(19) United States
(12) Patent Application Publication
(10) Pub. No.: US 2024/0258551 A1
(43) Pub. Date: Aug. 1, 2024

(54) LEAD TAB BENDING DEVICE OF SECONDARY BATTERY CELL AND BENDING METHOD USING THE SAME

(71) Applicant: HYUNDAI MOBIS CO., LTD., Seoul (KR)

(72) Inventor: Dong Kyu KIM, Uiwang-si (KR)

(73) Assignee: HYUNDAI MOBIS CO., LTD., Seoul (KR)

(21) Appl. No.: 18/382,206

(22) Filed: Oct. 20, 2023

(30) Foreign Application Priority Data
Jan. 31, 2023 (KR) 10-2023-0012441

(51) Int. Cl. H01M 10/04; B21D 7/024; H01M 50/54

(52) U.S. Cl. CPC H01M 10/0404; B21D 7/024; H01M 50/54

(57) ABSTRACT

The present invention relates to a lead tab bending device of a secondary battery cell capable of preventing a collision with equipment while eliminating a spring back phenomenon in bending the lead tab, and a bending method using the same. More specifically, a lead tab bending device of a secondary battery cell for bending the lead tab protruding from the secondary battery cell includes: a first guide having an extended length; a base block that moves linearly along the first guide; a second guide that is formed on one side of the base block and has an arc shape; and a bending jig that moves along the second guide and bends the lead tab, in which a center of a radius of rotation of the bending jig is formed on one side of the base block, and the bending jig rotates while the center is fixed.

### CROSS-REFERENCE TO RELATED APPLICATIONS

This application claims priority under 35 U.S.C. § 119 to Korean Patent Application No. 10-2023-0012441, filed on Jan. 31, 2023, in the Korean Intellectual Property Office, the disclosure of which is incorporated herein by reference in its entirety.

### TECHNICAL FIELD

The following disclosure relates to a technology for manufacturing and processing a secondary battery cell, and more particularly, to a lead tab bending device of a secondary battery cell and a bending method using the same.

### BACKGROUND

A secondary battery is a battery that can be charged and discharged, and includes a cathode, an anode, an electrolyte, and a separator, and stores and generates electricity using a voltage difference between different cathode and anode materials. The secondary battery may be configured to include an electrode assembly, an electrode tab protruding from the electrode assembly, and an exterior material wrapping the electrode assembly and the electrode tab. In this case, the secondary battery may be classified according to a type of exterior materials, and may be formed in a pouch type, a cylindrical shape, a prismatic shape, a roll shape, and the like.

The secondary battery may be used as an energy source for devices that require power, such as portable devices such as mobile phones, tablet PCs, and laptops, or eco-friendly mobility such as electric vehicles, and may be configured to include a secondary battery cell, which is a minimum unit, and a module, a pack, system, and the like in which a plurality of secondary battery cells are electrically connected according to the required power capacity.

There are various methods for a secondary battery to have maximum capacity. Among them, capacity versus volume may be increased by having the maximum number of secondary battery cells in the same volume. However, there is a limit to adjusting the size of the secondary battery cell, such as length, width, and thickness, in the secondary battery cell in the minimum unit and therefore, there is a limit to adjusting the size of the secondary battery cell in the minimum unit. In addition, in constructing a pack, since a plurality of modules should be generated and bundled to make the pack, there is a problem in that the accommodation capacity of the secondary battery cells is reduced by a frame of the module, and it is inefficient that time and cost are required to manufacture a separate module.

Therefore, since the modules, the packs, and the systems are used by connecting a plurality of secondary battery cells, it is necessary to develop a structure in which the plurality of secondary battery cells may be electrically connected to each other in a limited space and may be provided to the maximum. In particular, in using conductors such as busbars and assays when connecting the plurality of secondary battery cells, an electrode tab is combined with a conductor with a minimum volume, thereby requiring a structural feature that may be configured with a minimum volume.

Accordingly, the modules, the packs, and the systems are manufactured using a method of connecting a plurality of secondary battery cells by bending the electrode tabs of each secondary battery cell and combining the electrode tabs to the conductors so that it may be configured in a minimum volume while securing assemblability.

However, the generally configured electrode tab are made of a material that may not completely remove the elasticity of the material even when a force below or above the elastic limit is applied, and thus, even if the bending is performed at a desired angle or more, the phenomenon in which the material is restored to its original state may occur, and this phenomenon is called spring back.

Therefore, while bending the electrode tab to connect the plurality of secondary battery cells, the electrode tab may be smoothly bent to an angle to be operated while eliminating the spring back phenomenon, thereby providing a bending device and a bending method using the same capable of solving the collision problem of equipment that may occur during the process.

### SUMMARY

An embodiment of the present invention is directed to providing a lead tab bending device of a secondary battery cell and a bending method using the same which, when the secondary battery cells each are connected through the lead tabs to be assembled with a minimum volume but each lead tab is connected by being bent so that each lead tab overlaps adjacent lead tabs in order to solve the problem of securing assemblability and lack of space to accommodate the secondary battery cells, can solve spring back occurring due to material properties of the bent lead tabs and bend the lead tabs so that the problem of equipment collision and securing assemblability during the bending is solved.

In one general aspect, a lead tab bending device of a secondary battery cell for bending the lead tab protruding from the secondary battery cell includes: a first guide extending in length; a base block that moves linearly along the first guide; a second guide that is formed on one side of the base block and has an arc shape; and a bending jig that moves along the second guide and bends the lead tab, in which a center of a radius of rotation of the bending jig is formed on one side of the base block, and the bending jig rotates while the center is fixed.

The bending jig may include: a bending block that is coupled to the second guide and rotates; and a bending tip that extends from one end of the bending block to one side and has an edge formed through a pair of inclined surfaces having one end formed in a ridge shape.

At least a part of the bending tip may protrude from the bending jig to one side, and the center may be the edge of the bending tip.

The pair of inclined surfaces of the bending tip may be perpendicular to each other.

The one side may be a direction perpendicular to a longitudinal direction of the first guide, and the base block may include a moving device that moves to the one side or the other side forward or backward.

In another general aspect, a lead tab bending method of bending lead tabs of a plurality of secondary battery cells using the bending device described above includes: a) linearly moving the base block forward along the first guide in a reference position where a center axis of the bending jig coincides with the center; b) rotating the bending jig at a predetermined angle along the second guide; c) moving the base block forward in one direction by a moving device and contacting one end of the bending jig with the lead tab, the base block including the moving device movable in a perpendicular direction to a longitudinal direction of the first guide; d) performing primary bending on the lead tab while the bending jig rotates along the second guide in an opposite direction in step b); and e) performing secondary bending on the lead tab while the base block moves linearly along the first guide in a rotational direction of the primary bending.

After step e), step a) may be repeatedly performed according to the number of secondary battery cells, and in step a) repeatedly performed, the base block may sequentially move to positions of adjacent lead tabs along the first guide.

Whenever steps b) to e) are repeatedly performed, the rotational direction of the bending jig may alternately rotate and move in an opposite direction to each other so that the lead tabs adjacent to each other among the plurality of lead tabs arranged side by side are bent in an opposite direction to each other.

In step b), one inclined surface at one end of the bending jig rotating by the primary bending may be horizontal to a plane of the sensing assay.

After step b), the bending jig may return to the reference position, and step e) may be performed.

### BRIEF DESCRIPTION OF THE DRAWINGS

FIG. 1 is an overall perspective view of a lead tab bending device of the present invention.

FIG. 2 is an overall plan view of the lead tab bending device of the present invention.

FIG. 3 is an overall side view of the lead tab bending device of the present invention.

FIG. 4 is an overall front view of the lead tab bending device of the present invention.

FIG. 5 is a partial perspective view of the lead tab bending device in which a part of a base block of the present invention is removed.

FIG. 6 is a partial plan view of the lead tab bending device in which a part of the base block of the present invention is removed.

FIG. 7 is a first perspective view of a bending jig of the present invention.

FIG. 8 is a second perspective view 2 of the bending jig of the present invention.

FIG. 9 is a front view of a sensing assay of the present invention.

FIG. 10 is a diagram illustrating the operation of a part of a plurality of lead tabs inserted into the sensing assay of the present invention and the lead tab bending device of the present invention.

FIG. 11 is a flowchart of a lead tab bending method of bending a lead tab of a secondary battery cell using the lead tab bending device of the present invention.

### DETAILED DESCRIPTION OF MAIN ELEMENTS

| | |
|---|---|
| 1000: Bending device | |
| 100: First guide | |
| 200: Base block | 210: Moving device |
| 300: Second guide | |
| 400: Bending jig | 410: Bending tip |
| 410a: Edge | 411: Inclined surface |
| 412: Protrusion | 420: Bending block |
| 11: Lead tab | |
| 20: Sensing assay | 21: Through hole |
| 22: Plane | |

### DETAILED DESCRIPTION OF EMBODIMENTS

Hereinafter, the technical spirit of the present invention will be described in more detail with reference to the accompanying drawings. Terms and words used in the present specification and claims are not to be construed as a general or dictionary meaning, but are to be construed as meaning and concepts meeting the technical ideas of the present invention based on a principle that the present inventors may appropriately define the concepts of terms in order to describe their inventions in best mode.

Therefore, configurations described in exemplary embodiments and the accompanying drawings of the present invention do not represent all of the technical spirits of the present invention, but are merely most preferable embodiments. Therefore, the present invention should be construed as including all the changes, and substitutions included in the spirit and scope of the present invention at the time of filing this application.

Hereinafter, the technical spirit of the present invention will be described in more detail with reference to the accompanying drawings. However, the accompanying drawings are only examples shown in order to describe the technical idea of the present invention in more detail. Therefore, the technical idea of the present invention is not limited to shapes of the accompanying drawings.

The present invention is an invention that may contribute to securing a manufacturing technology necessary to form a pack with maximum capacity, and is an apparatus that may be applied to a cell to pack (CTP) manufacturing technology that immediately installs a plurality of secondary battery cells in a housing of a pack without assembling a module. The CTP manufacturing technology has an advantage in that the capacity of the battery may increase to the maximum by reducing a packaging portion into which a module is to enter and inserting more secondary battery cells into the remaining space. In this case, in the plurality of secondary battery cells accommodated in the pack, the pack may be configured by electrically connecting each lead tab to a sensing assay of a conductor by a contact. In addition, lead tabs of each secondary battery cell contact and connect to the sensing assay, respectively. In this case, the electrical connection is formed by bending the lead tab so that the plane of the lead tab is in horizontal contact with the plane of the sensing assay. Accordingly, in a lead tab bending device 1000 of a secondary battery cell, lead tabs of a secondary battery cell adjacent to each other may be bent without colliding with each other and a secondary battery pack assembly may be automated through the bending device 1000, thereby providing a manufacturing technology of improving stability and productivity.

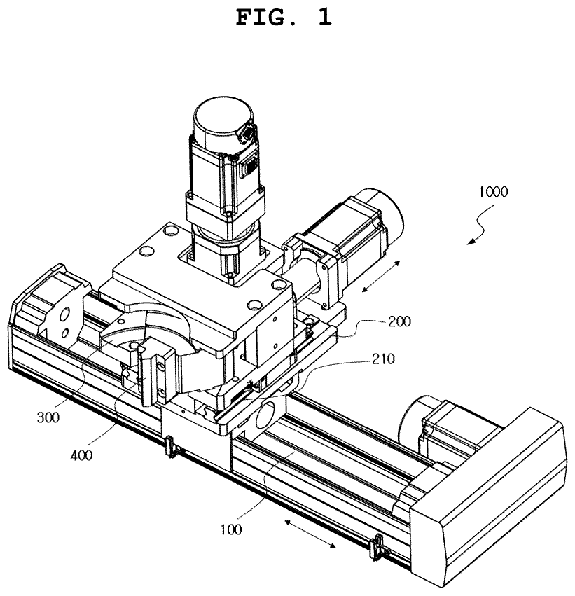

Referring to FIG. 1, the present invention relates to a bending device 1000 for bending a lead tab protruding from a secondary battery cell. The bending device 1000 includes a first guide 100 having an extended length, a base block 200 that moves linearly along the first guide 100, a second guide 300 that is formed on one side of the base block 200 and has an arc shape, and a bending jig 400 that moves along the second guide 300 and bends the lead tab. In this case, a center of a radius of rotation of the bending jig 400 is formed on one side of the base block 200, and the bending jig 400 rotates while the center is fixed. That is, in the bending device 1000, the base block 200 moves along a rail of the first guide 100, and the bending jig 400 moves along a rail of the second guide 300. In this case, the first guide 100 is a straight rail, and the second guide 300 is an arc rail.

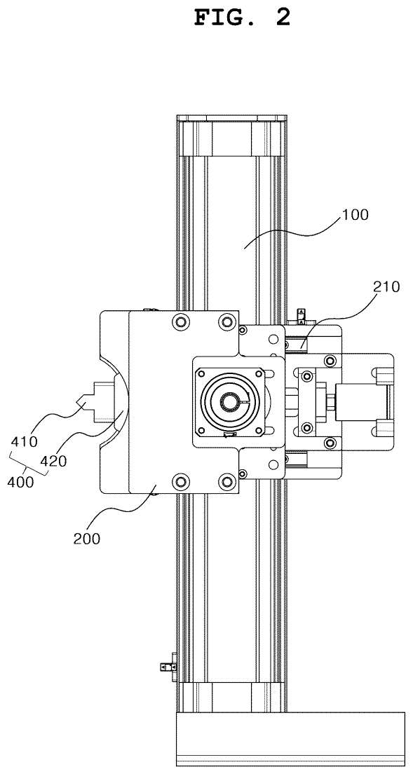

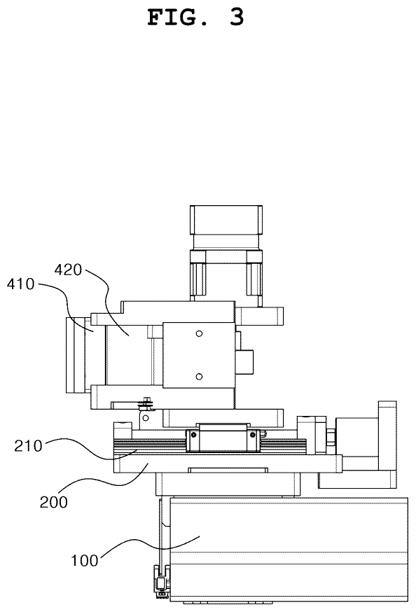

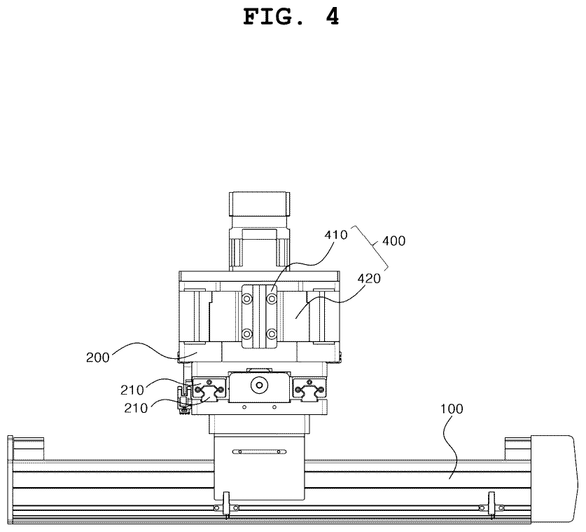

The present invention includes the first guide 100 having a length extending in one direction. Referring to FIGS. 1 to 4, the first guide 100 is a rail on which a straight line is formed in one direction, and the base block 200 may be mounted on the first guide 100. It is preferable that the first guide 100 is arranged so that its longitudinal direction is parallel to the direction in which the lead tab is folded. In the first guide 100, an arrangement direction of the lead tabs and an extending direction of the first guide 100 may be arranged side by side so that the lead tabs of the plurality of secondary battery cells move along the direction in which they are arranged in parallel. In this case, the length of the first guide 100 may correspond to the sum of the lead tabs of the plurality of secondary battery cells. As an example, the first guide 100 moving horizontally will be described below.

The base block 200 is mounted on the first guide 100 and moves linearly along the longitudinal direction of the first guide 100. Referring to FIGS. 1 to 4, the base block 200 is a device that moves to the position of the lead tab to be operated, and while the base block moves along the first guide 100, the base block may include the second guide 300 on one side, and may be formed to a predetermined width so that the bending jig 400 may be mounted on the second guide 300. In this case, the one side may be either side in a direction perpendicular to the longitudinal direction of the first guide 100. When the base block 200 is movably coupled to the first guide 100, various coupling configurations may be applied depending on the need and purpose, such as a configuration in which the rail is inserted into a groove of the rail or moves through wheels, or a LM guide structure in which the rail is wrapped around and moves. The base block 200 is not limited to a specific shape or size, or the like and may be formed in various ways as needed. For example, the base block 200 may have a length in a direction perpendicular to the longitudinal direction of the first guide 100, and the second guide 300 may be formed on one side of the base block 200 in the longitudinal direction. The base block 200 may be configured of a device capable of transmitting and receiving signals from the outside, and may be automatically moved by power such as a motor. In addition, the base block 200 includes a moving device 210 that moves the base block 200 in a direction perpendicular to the first guide 100 so that the lead tab to be operated may be accessed. That is, the moving device 210 moves the base block 200 one side or the other side in a state where the base block 200 is coupled to the first guide 100. The moving device 210 may be configured of a device capable of transmitting and receiving signals from the outside, and may be automatically moved by power such as a motor. Accordingly, hereinafter, it will be described that the direction to the one side is forward and the direction to the other side is backward.

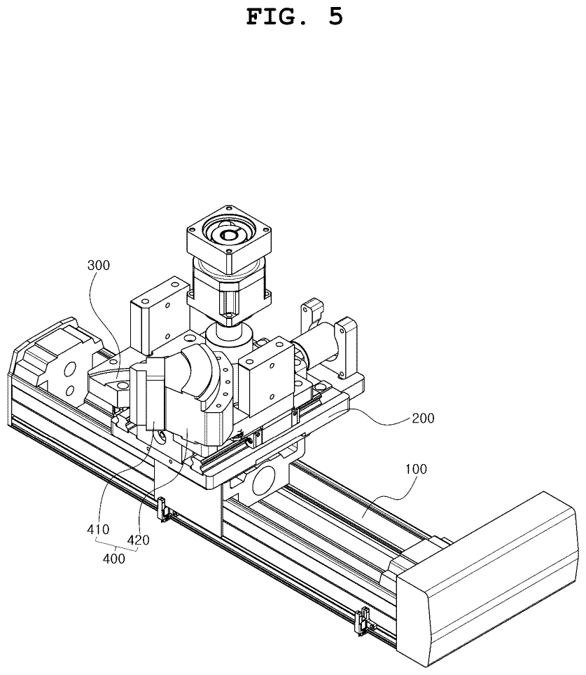

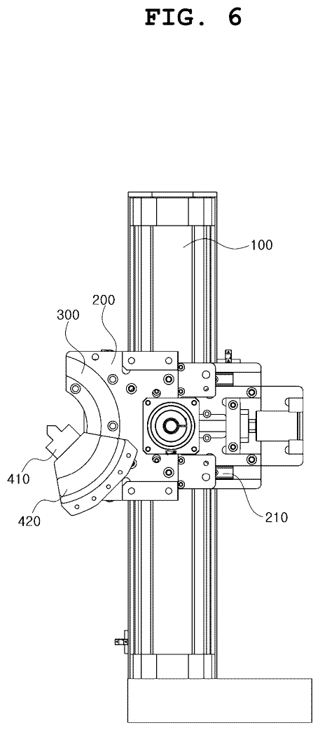

According to the present invention, the second guide 300 is formed on one side of the base block 200 in an arc shape. FIGS. 5 and 6 are diagrams illustrating the second guide with an upper housing of the base block removed, and the second guide 300 is formed on one side of the base block 200 and is formed in a curved shape. In addition, depending on the shape of the rail of the second guide 300, the bending direction or angle of the bending device 1000 is determined. In this case, the second guide 300 is an arc that is at least a part of the circumference. In more detail, the second guide 300 is an arc, which is a part of a circumference of a circle having a radius of R. The length of the rail of the second guide 300 may be greater than or less than a semicircle, or may be a length along a predetermined circumference of a circle determined as needed. For example, the second guide 300 may be a U-shaped circular arc having a concave curvature, and more specifically, is formed with a curvature recessed toward the other side of the base block 200. The length of the rail of the second guide 300 is arranged along an edge 410a at one end of the base block 200. That is, the second guide 300 may be formed in an arc, but may be formed in a rainbow shape so that each end is positioned in a horizontal direction of the first guide 100.

The bending jig 400 is mounted on the second guide 300 and rotates along the second guide 300. Referring to FIGS. 5 and 6, the bending jig 400 may be freely formed without any particular limitation as long as it is mounted on the second guide 300 and has a movable shape and size. In addition, when the bending jig 400 is movably coupled to the second guide 300, as the coupling method, various coupling configurations may be applied depending on the need and purpose, such as a configuration in which the rail is inserted into a groove of the rail or moves through wheels or a LM guide structure in which the rail is wrapped around and moves. It is preferable that one end of the bending jig 400 comes into contact with the lead tab, and the bending jig 400 rotates along the second guide 300 while being in contact with the lead tab, and the bending jig 400 is a device that bends the lead tab. The rail of the second guide 300 may be formed to have a length along the edge 410a on one side of the base block 200, and as the bending jig 400 rotates along the second guide 300, the lead tab is bent in one of the longitudinal and horizontal directions of the first guide 100, and the bending angle of the lead tab may be determined according to the rotation angle of the bending jig 400. The bending jig 400 may be composed of a device capable of transmitting and receiving signals from the outside, and may be automatically moved by power such as a motor.

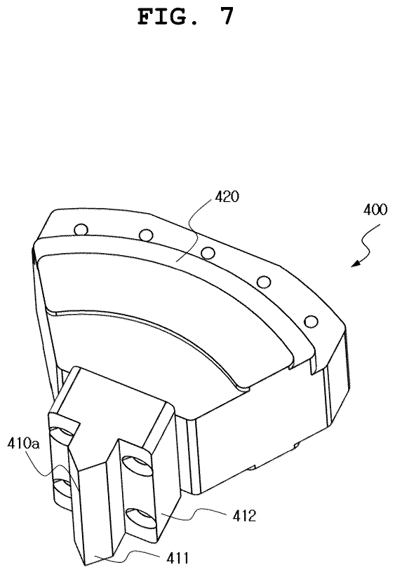

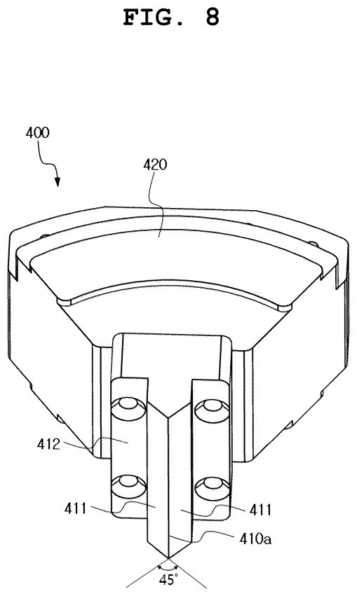

Describing in more detail with reference to FIGS. 6 to 8, the bending jig 400 of the present invention is configured to include a bending block 420 that is coupled to the second guide 300 and rotates, and a bending tab 410 that extends from one end of the bending block 420 to one side, and is provided with an edge 410a through a pair of inclined surfaces 411 having one end formed in a ridge shape. Accordingly, the bending tip 410 comes into contact with the lead tab, and the lead tab is bent by the rotational movement of the bending block 420. As long as the bending block 420 is formed to be movable along the rail of the second guide 300 by being coupled to the second guide 300, the bending block 420 may be freely configured without limiting the shape and size. As illustrated in FIGS. 7 and 8, the bending tip 410 has an edge 410a formed at one end, and each one side of a pair of inclined surfaces 411 having a plane in one direction is in contact with each other to form the edge 410a. That is, as the pair of inclined surfaces 411 are coupled into a ridge shape, which is a shape of a mountain top, the edge 410a is a portion which the inclined surfaces 411 meet each other. In addition, the rotation angle of the bending jig 400 may be determined according to the angle formed by the pair of inclined surfaces 411 of the bending tip, which may be freely selected according to the configuration of the device or the features of the object. For example, referring to FIG. 8, by considering the maximum angle at which the bending tip 410 can maintain the strength when the lead tab is bent secondarily by the linear movement of the bending tip 410 while minimizing the rotation angle of the bending jig 400, the pair of inclined surfaces 411 may have an angle of about 90° therebetween. In addition, the bending tip 410 may include an extension part 412 that extends in one direction from one end of the bending block 420, and the extension part 412 connects the bending block 420 and the inclined surface 411. The width and length of the extension part 412 may be formed to an appropriate length as needed, and are preferably set in consideration of a spacing between the lead tabs, a dimension of equipment, or the like in order to avoid collision and interference of devices during the operation of the bending jig 400. In one embodiment of the present invention, the width of the extension part 412 is formed smaller than the bending block 420, and the length of the extension part 412 is a length in which at least a part of the extension part 412 protrudes outward from the bending jig 400. Accordingly, at least a part of the bending tip 410 is formed to protrude from the bending jig 400 to one side. In addition, since the edge 410a comes into contact with the lead tab, the length of the edge 410a is formed along the longitudinal direction of the lead tab, and the length of the edge 410a preferably corresponds to the length of the lead tab. Further, the width of the inclined surface 411 may be formed to be less than or equal to the width of the lead tab. It is particularly preferable that the width of the inclined surface 411 is less than or equal to the width of the bent lead tab. Accordingly, the bending tip rotates while the width of one of the pair of inclined surfaces 411 comes into contact with the width of the lead tab, so it is possible to prevent collisions with other parts during the bending.

Further, according to the present invention, the bending jig 400 rotates along the second guide 300, and the center of the radius of rotation of the bending jig 400 is formed on one side of the base block 200. That is, as illustrated in FIG. 6, the second guide 300 is formed in an arc shape, and the center of the radius of the arc is at one side of the base block 200. In this case, according to the present invention, the center is formed on the outside of one side of the base block 200. Accordingly, when the bending jig 400 rotates, one side of the bending jig 400 is fixed and the other side positioned on the base block 200 moves along the second guide 300. More specifically, the second guide 300 is formed at one end of the base block 200, and the bending jig 400 rotates while connected to the second guide 300. The bending jig 400 includes the bending block 420 coupled to the second guide 300 and the bending tip 410 formed at a portion extending from the bending block 420 to one side. In addition, the edge 410a is formed at one end of the bending tip, and thus, the edge 410a is the center of the radius of rotation of the bending jig. That is, the portion of the bending block 420 rotates along the second guide 300 while the edge 410a of the bending tip 410 is fixed, so the bending jig 400 performs the rotational movement. The radius of rotation R of the bending jig 400 may correspond to a length from any one point of the second guide 300 to the edge 410a, and the center of the radius of rotation of the bending jig 400 may coincide with the center of the radius of rotation of the second guide 300. The radius of rotation R is preferably formed as the shortest distance in order to optimize the bending device. In addition, when the bending tip 410 comes into contact with the pair of inclined surfaces 411 at a perpendicular angle and the edge 410a is formed, regarding the angle of rotation of the bending jig 400, the center axis is between the inclined surfaces 411 around the edge 410a, and the bending jig 400 may rotate at an angle of 45° or more left and right, respectively, around the central axis.

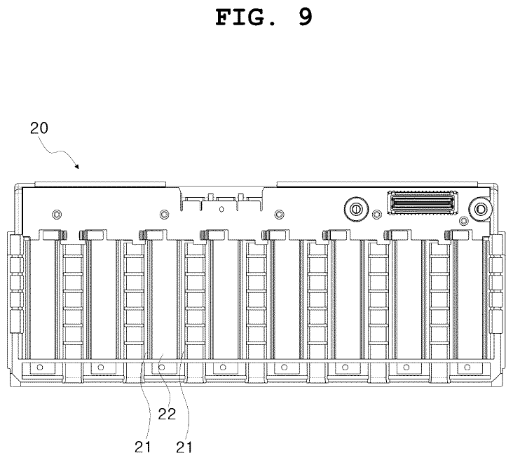

A lead tab bending method of bending each of the lead tabs 11 in packing a plurality of secondary battery cells into a pack using the lead tab bending device 1000 of a secondary battery cell having the above characteristics will be described. In this case, the length of the first guide 100 extends horizontally in the left and right directions, and the base block 200 moves to one side or the other side in a direction perpendicular to the longitudinal direction of the first guide 100 by the moving device 210, in which the one side will be described as forward and the other side will be described as backward. Accordingly, the base block 200 moves in the left and right directions along the first guide 100, and the base block 200 may move in the forward and backward directions through the moving device 210. In addition, the plurality of secondary battery cells are accommodated in the pack, and lead tabs of the secondary battery cells are arranged parallel to each other in the pack. The pack connects the plurality of secondary battery cells through the sensing assay 20. FIG. 9 is a front view of the sensing assay 20, in which the plurality of through holes 21 are formed in the sensing assay 20 along the arrangement direction of the lead tab 11, and each through hole 21 preferably has a size through which at least one of the lead tabs 11 may pass. In this case, the sensing assay 20 is a path to which a sensor may be connected, and may be expressed as a busbar assay 20. In the sensing assay 20, the plane 22 is formed between the through holes 21, and the lead tab 11 bent toward the plane 22 comes into contact with the plane 22 and welded. By doing so, the plurality of the secondary battery cells may be electrically connected by the sensing assay 20 to form the pack. In this case, the secondary battery cell and the sensing assay 20 may be arranged on one side of the base block 200, which is one side of the bending device.

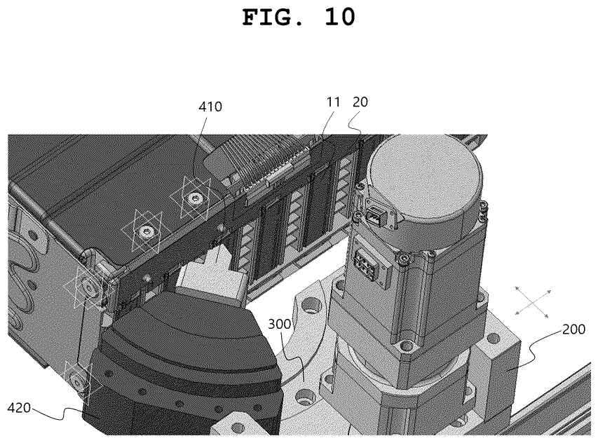

The bending device 1000 of the present invention is a device capable of performing bending to solve the problem of the spring back of the lead tab 11. Accordingly, referring to FIG. 10, the bending device 1000 performs the primary bending and the secondary bending on the lead tab 11, thereby eliminating the spring back. In this case, the primary bending is the rotational bending that bends the lead tab 11, and may be performed by the rotation of the bending jig 400. Even after the primary bending, the lead tab 11 may cause the spring back in which the lead tab 11 is not bent at a desired angle due to material characteristics and returns to a predetermined position. Accordingly, the secondary bending is pressing the lead tab once more by pushing the bent lead tab 11 to the bending tip 410, and the spring back is eliminated through the secondary bending. That is, the bending device may bend the lead tab at an optimal angle while eliminating the spring back of the lead tab 11 by performing the rotational motion and the linear motion together to bend the lead tab 11. Accordingly, it is preferable that the bending device 1000 is movable in both the left and right directions and the front and rear directions. All configurations in which the bending jig 400 may rotate along the second guide 300 while the center is fixed are allowed.

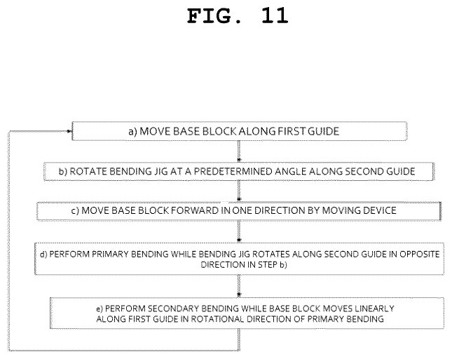

Referring to FIG. 11, in the lead tab bending method of bending lead tabs of a plurality of secondary battery cells using the bending device 1000, a) linearly moving the base block 200 along the first guide 100 in a reference position where a center axis of the bending jig 400 coincides with the center, b) rotating the bending jig 400 at a predetermined angle along the second guide 300, c) moving the base block 200 forward in one direction by a moving device 210 and contacting one end of the bending jig 400 with the lead tab 11, the base block 200 including the moving device 210 movable in a perpendicular direction to the longitudinal direction of the first guide 100, d) performing the primary bending while the bending jig 400 rotates along the second guide 300 in an opposite direction in step b), and e) performing secondary bending on the lead tab 11 while the base block 200 moves linearly along the first guide 100 in a rotational direction of the primary bending.

In the present invention, before step a) is performed, a preparation step of arranging the plurality of secondary battery cells so that the lead tabs 11 are parallel to each other and packaging the sensing assay 20 in the pack by passing at least one lead tab 11 through each through hole 21 may be performed. The preparation step may be a step of packing the plurality of secondary battery cells into the pack. In this case, the plurality of secondary battery cells are arranged so that the lead tabs 11 are parallel in one direction, and the plurality of secondary battery cells may be connected by passing through at least one of the lead tabs 11 and coupling the lead tab to the through hole 21 of the sensing assay 20. It is preferable that the lead tab 11 is in the form of a plane having a predetermined thickness, and has a length, width, and thickness, and the through hole 21 has a length equal to or longer than the length of the lead tab 11 and a width equal to or greater than the thickness of the lead tab 11, and thus, the longitudinal directions of each through hole 21 and the lead tab 11 are inserted correspondingly. The spacing of the through holes 21 on the sensing assay 20 may be freely adjusted according to the thickness of the secondary battery or as needed. The through hole 21 may be formed to correspond to the number of secondary battery cells provided. The sensing assay 20 includes the plurality of planes 22 between the through holes 21, and the planes 22 and the through holes 21 are alternately arranged. The plane 22 may have a width equal to or greater than that of the lead tab 11, and particularly preferably has a width corresponding to that of the folded lead tab 11. The bending device 1000 bends a pair of lead tabs 11 so that the pair of lead tabs 11 comes into contact with one plane 22 of the sensing assay 20. The preparation step is a step of inserting the plurality of lead tabs 11 into each through hole 21 of the sensing assay 20 and bundling and packing the plurality of lead tabs 11 with the sensing assay 20.

Referring to FIG. 11, step a) of moving the base block 200 in the left and right directions is performed so that the plurality of lead tabs 11 move to the position of the lead tab to be bent. Step a) is a step of linearly moving the base block 200 along the first guide 100 and moving to the left or right, and moving the base block 200 to the position of the corresponding lead tab 11. In this case, the bending jig 400 moves to the reference position which is a position where the center axis of the bending jig 400 coincides with the center. This means that the edge 410a of the bending tip 410 coincides with the center of the bending jig 400, and the reference position may be the position of the bending jig 400 which is positioned at the center of the second guide 300.

Referring to FIG. 11, before moving the bending jig 400, which horizontally moves in the left and right directions in step a), forward to the position of the lead tab 11, step b) of rotating the bending jig 400 at a predetermined angle is performed. In the bending jig 400, the bending tip 410, which is one end of the bending jig 400, is formed in the ridge shape by the pair of inclined surfaces 411. Since the lead tab 11 is arranged so that the thickness portion faces the bending tip 410, an angle difference is generated between the inclined surface 411 of the bending tip 410 and the area portion of the lead tab 11. Accordingly, step b) is a step of adjusting the position of the bending jig 400 so that the inclined surface 411 may be parallel to the area of the lead tab 11 by rotating at a predetermined angle. In this case, regarding the predetermined angle, it is preferable that the plane of one of the pair of inclined surfaces 411 rotates at an angle that is parallel to the plane of the lead tab 11. Accordingly, the predetermined angle at which the bending jig 400 rotates in step b) is determined according to the angle between the pair of inclined surfaces 411. In step b), in the bending jig 400, the edge 410a of the bending tip 410 may be fixed to the center, the portion of the bending block 420 may rotate in the left and right directions along the second guide 300, and the rotational direction is the direction opposite to the direction in which the lead tab 11 is bent. Describing in detain with an example, when the bending device 1000 first bends the lead tab 11 toward the left side, in step b), the bending jig 400 rotates to the right at a predetermined angle, and an angle is formed so that the inclined surface 411 on the left comes into contact with the right area of the lead tab 11.

Referring to FIG. 11, in order to move the lead tab 11 to the position of the lead tab 11 in the bending jig 400 whose angle for bending the lead tab 11 is adjusted, step c) of moving the base block 200 forward using the moving device 210 of the base block 200 is performed. In this case, a plurality of secondary battery cells are arranged on the front surface of the base block 200. Step c) is a step of moving the base block 200 so that, in the bending tip 410 rotating at the predetermined angle, the edge 410a of the bending tip 410 comes into contact with the position where the lead tab 11 is bent. That is, step c) is a step of allowing the moving means to move the base block 200 forward so that the edge 410a comes into contact with the position where the lead tab 11 is bent. Describing in detail with an example, when the bending device 1000 first bends the lead tab 11 toward the left side, in step b), the bending jig 400 rotates to the right at a predetermined angle, and in step c), the bending jig 400 rotates to the left. This is to set an angle at which the lead tab 11 may rotate while maximally preventing the interference or collision of other devices due to the rotation of the bending tip 410, and then, adjust the positions of the edge 410a and the bending portion of the lead tab 11.

Then, referring to FIG. 11, step d) of performing the primary bending in which the bending jig 400 rotates along the second guide 300 is performed. Step d) relates to the primary bending, and is a step of performing an operation of bending the lead tab 11 in one of left and right directions. The primary bending is performed when the edge 410a of the bending tip 410 is fixed around the radius of rotation and the bending block 420 moves along the second guide 300. The lead tab 11 is bent toward the plane 22 of the sensing assay 20 by the primary bending. In this case, the rotational direction in step d) is a direction opposite to the rotational direction of the predetermined angle in step b). Accordingly, the rotation angle in step d) rotates greater than the rotation angle in step b). Further, the rotation angle in step d) preferably rotates at an angle greater than the angle at which the lead tab 11 is to be bent, and may be determined by considering the angle between the inclined surfaces 411 of the bending tip 410. As an example of the present invention, when the inclined surfaces 411 are disposed perpendicular to each other, in the step d), the primary bending may be performed by rotating the bending jig 400 at an angle of 90°. Accordingly, in step d), in the bending jig 400 rotating by the primary bending, among the pair of inclined surfaces 411, the bending jig 400 operates to the degree that the inclined surface 411 on the rotational direction side of the bending jig 400 is horizontal to the plane 22 of the sensing assay 20.

Referring to FIG. 11, the bending jig 400 rotating in any direction by step d) may rotate again to the reference position where the edge 410a of the bending tip 410 coincides with the center of the bending jig 400 in order to perform the next step. That is, the step of returning the bending jig 400 to the reference position after the primary bending may be additionally performed.

Then, referring to FIG. 11, step e) of linearly moving the base block 200 linearly along the first guide 100 and performing secondary bending on the lead tab 11 is performed. Step e) is a step for eliminating the spring back occurring in the lead tab 11 when the first bending is performed. The secondary bending is a step of re-bending by pressing the lead tab 11 through the linear motion, and in step d), the base block 200 horizontally moves in the direction in which the bending jig 400 rotates while the bending tab comes into contact with the lead tab 11. The secondary bending means that the bending jig 400 moves in the left and right directions in the reference position state. That is, in step e), the edge 410a of the bending tip 410 presses an area portion of the lead tab 11 bent by the primary bending and the bending jig 400 moves in the bent direction, and the bending jig 400 moves by moving the base block 200 along the first guide 100. Describing in detail with an example, when the bending device 1000 first bends the lead tab 11 toward the left side, in step b), the bending jig 400 rotates to the right at a predetermined angle, and in step c), the bending jig 400 rotates to the left, and then, in step e), the base block 200 linearly moves to the left while the edge 410a of the bending tip 410 comes into contact with the bent portion of the lead tab 11. Therefore, although the lead tab 11 is bent by the primary bending in step e), regarding the problem of the spring back occurring due to the material characteristics, step e) is a step of pressing the lead tab 11 once more by linearly moving the bending jig in order to more completely bend the lead tab 11.

In addition, the present invention relates to the bending device 1000 capable of facilitating the pack packaging of the plurality of secondary battery cells by bending all the lead tabs so that the plurality of secondary battery cells accommodated in the sensing assay 20 contact the sensing assay 20, and the lead tab bending method using the bending device 1000. Therefore, according to the present invention, an operation of bending all of the plurality of lead tabs accommodated in the sensing assay 20 is performed using the bending device 1000. In this case, according to the present invention, in the plurality of lead tabs arranged side by side, the lead tabs 11 adjacent to each other are cross-bent so that they are bent in an opposite direction to each other. Further, in the plurality of lead tabs 11 inserted into the sensing assay 20, the lead tab bending may be performed while sequentially moving in one direction.

Accordingly, referring to FIG. 11, in the lead tab bending method of bending a lead tab of a secondary battery cell using the bending device 1000 of the present invention, according to the number of secondary battery cells, step a) after step e) is repeatedly performed. For step a) repeatedly performed, the plurality of lead tabs are repeatedly bent sequentially while the base block 200 moves to the position of the lead tab adjacent to the previously bent lead tab along the first guide 100. When the number of secondary battery cells is n, first, first step a) to step e) are sequentially performed on the lead tab at one end of the lead tabs 11 arranged side by side, and after step e), step a) is repeated n−1 times. Describing in detail with an example, when the number of secondary battery cells accommodated in the pack is 20, 20 through holes 21 are formed at regular intervals in the sensing assay 20, respectively, and the preparation step is performed by arranging planes 22 between the through holes 21, respectively, and inserting the lead tabs of the secondary battery cells into each of the through holes 21. Further, in the present invention, by repeating step a) 19 times after step e), a total of 20 lead tabs are bent and attached to the plane 22 side of the sensing assay 20. In this case, first step a) is performed by linearly moving the base block 200 to the position of the lead tab at either end, and then, in second step a), the base block 200 block linearly moves slightly in the arrangement direction of the lead tab 11 from a position of first step a), and second step a) is performed. Thereafter, in each step a) from third to twentieth, by linearly moving the base block 200 as much as the distance between the lead tabs 11 along one direction, each step a) is performed. In this case, either direction is the left direction or the right direction as the linear direction of the first guide 100.

In addition, in steps b) to e), the rotational direction of the bending jig 400 rotates and moves alternately to the left or right so that the lead tabs 11 adjacent to each other are bent in an opposite direction to each other every repetition after the first execution. This is to allow a pair of lead tabs to overlap each other on one plane 22 of the sensing assay 20. That is, the through holes 21 are formed on both sides of either plane 22 of the sensing assay 20 and each lead tab is passed through and inserted into each of the through holes 21. In the bending device of the present invention, the lead tabs 11 on both sides are bent toward the plane 22, which is a direction facing each other, so that the lead tabs 11 arranged on both sides with the plane 22 therebetween are in contact with the plane 22 in the middle. For example, in more detail, as in the previous example, the number of secondary battery cells accommodated in the pack is 20, and after the plurality of lead tabs are inserted into the sensing assay 20 through the preparation step, when the bending device 1000 of the present invention sequentially performs bending from the right end along the left side, first step a) to step e) are performed on the lead tab at the right end, but in step b), the bending jig 400 rotates to the right at a predetermined angle, and steps d) and e) each performs the first step by rotating and moving the bending jig 400 to the left. Second step a) is performed. In this case, in step a), the base block 200 moves slightly to the left, and in step b), the bending jig 400 rotates to the left at a predetermined angle, and in each step d) and e), the bending jig 400 rotates and moves to the right, and the second step is performed. Thereafter, in third step b), the bending jig 400 rotates to the right at a predetermined angle, and in steps d) and e), the bending jig 400 rotates and moves to the left, respectively. In this way, sequentially, in each step b) to step e), the bending jig 400 operates in the opposite direction to the previous repetition step. In this case, the pair of lead tabs 11 are repeatedly performed alternately in directions facing each other toward the plane 22 in the middle. In order to bend each lead tab to overlap while facing each other when performing the above steps repeatedly, it is important that each lead tab 11 is bent at more angles by maximally eliminating spring back so that the lead tabs 11 that are bent facing each other do not collide with each other. Accordingly, the bending device 1000 of the present invention is a device capable of performing both primary bending of rotational bending and secondary bending of straight bending in the bending of the lead tab. In addition, in the plurality of lead tabs arranged adjacently at small spacing, when operating on each lead tab, it is possible to move the bending jig 400 by rotating the angle of the bending jig 400, so it is possible to prevent a collision with equipment, thereby performing the bending operation more accurately and safely.

The lead tab bending device of a secondary battery cell and a bending method using the same of the present invention having the configuration described above relate to a device and method of folding a lead tab of a secondary battery cell for constructing a secondary battery pack by folding neighboring lead tabs facing each other to electrically connect a plurality of secondary battery cells and contacting the plurality of secondary battery cells to a busbar. By connecting the secondary battery cells to each other with a smaller volume to overcome the structural limitations along with the lack of space, it is possible to improve the overall capacity of a high-capacity secondary battery device and solve the spring back of the lead tab made of metal, and in particular, by designing to avoid collision of the folded lead tab or a collision with equipment when folding adjacent lead tabs to face each other, it is possible to provide a manufacturing device capable of improving stability and productivity by performing automation for both end bending.

Hereinabove, although the present invention has been described by specific matters such as detailed components, exemplary embodiments, and the accompanying drawings, they have been provided only for assisting in the entire understanding of the present invention. Therefore, the present invention is not limited to the exemplary embodiments. Various modifications and changes may be made by those skilled in the art to which the present invention pertains from this description.

Therefore, the spirit of the present invention should not be limited to these exemplary embodiments, but the claims and all of modifications equal or equivalent to the claims are intended to fall within the scope and spirit of the present invention.

1. A lead tab bending device for bending a lead tab, the lead tab bending device comprising:
a first guide having an extended length;
a base block configured to move linearly along the first guide;
a second guide disposed on one side of the base block and having an arc shape; and
a bending jig configured to move along the second guide to bend the lead tab,
wherein a center of a radius of rotation of the bending jig is disposed on the one side of the base block, and the bending jig rotates while the center is fixed.

2. The lead tab bending device of claim 1, wherein the bending jig includes:
a bending block coupled to the second guide and configured to rotate; and
a bending tip that extends from one end of the bending block to one side of the base block and has an edge in a ridge shape where a pair of inclined surfaces of the bending tip meet.

3. The lead tab bending device of claim 2, wherein at least a part of the bending tip protrudes from the bending jig to the one side of the base block, and
the center is the edge of the bending tip.

4. The lead tab bending device of claim 2, wherein the pair of inclined surfaces of the bending tip are perpendicular to each other.

5. The lead tab bending device of claim 1, further comprising a moving device configured to move the base block forward and backward in a direction perpendicular to a longitudinal direction of the first guide.

6. A lead tab bending method of bending lead tabs of a plurality of secondary battery cells using a bending device comprising a first guide, a base block, a second guide, and a bending jig, the method comprising:
a) linearly moving the base block along the first guide in a reference position where a center axis of the bending jig coincides with the center;
b) rotating the bending jig at a predetermined angle along the second guide;
c) moving the base block forward in one direction by a moving device which moves the base block in a direction perpendicular to a longitudinal direction of the first guide, and contacting one end of the bending jig with the lead tab;
d) performing primary bending on the lead tab while the bending jig rotates along the second guide in an opposite direction in step b); and
e) performing secondary bending on the lead tab while the base block moves linearly along the first guide in a rotational direction of the primary bending.

7. The lead tab bending method of claim 6, wherein after step e), step a) is repeatedly performed according to the number of secondary battery cells, and
in step a) repeatedly performed, the base block sequentially moves to positions of adjacent lead tabs along the first guide.

8. The lead tab bending method of claim 7, wherein when steps b) to e) are repeatedly performed, the rotational direction of the bending jig alternately rotates and moves in an opposite direction to each other so that the lead tabs adjacent to each other among the plurality of lead tabs arranged side by side are bent in an opposite direction to each other.

9. The lead tab bending method of claim 6, wherein in step b), one inclined surface at one end of the bending jig rotating by the primary bending is horizontal to a plane of the lead tab.

10. The lead tab bending method of claim 6, wherein after step b), the bending jig returns to the reference position, and step e) is performed.
